(19) United States
(12) Patent Application Publication
(10) Pub. No.: US 2007/0203433 A1
(43) Pub. Date: Aug. 30, 2007

(54) Relaxation inducing apparatus

(76) Inventor: Martin Paul Murphy, New York, NY (US)

Correspondence Address: Martin Murphy, 317 2nd Avenue, Bsm.t, New York, NY, 10003, US

(21) Appl. No.: 11/657,831

(22) Filed: Jan. 25, 2007

Related U.S. Application Data
(60) Provisional application No. 60/776,997, filed on Feb. 27, 2006.

(51) Int. Cl. A61H 1/00

(52) U.S. Cl. 601/15

(57) ABSTRACT

A wearable relaxation inducing apparatus comprises either a harness or a garment made of elastically flexible fabric tightly worn on the torso; electromechanical sensors attached to the fabric translating the breathing movements of a wearer into electric signals representing breathing rate and depth; electrically operated transducers attached to the fabric providing tactile feedback to the body about breathing; and electronic circuitry for processing the electrical signals produced by the electromechanical sensors and for operating the transducers at selected adjustable sequences and rates.

### FIELD OF THE INVENTION

This patent application refers to and completes the provisional patent application No. U.S. 60/776,997 of the same title, which was submitted to the USPO by the inventor on Feb. 27, 2006.

The present invention generally relates to apparatus for enhancing the perception and awareness of human physiological functions, such as breathing, by providing corresponding information or feedback to its user. More particularly, it relates to inconspicuous apparatus based on the above principles and designed to facilitate the induction of relaxation and of meditative states.

### BACKGROUND OF THE INVENTION

Relaxation is often achieved by paying particular attention to breathing, such as taking deep breaths. Meditation is a group of ancient techniques of Indian origin (yoga) for attaining relaxation and a peaceful state of mind, possibly leading to more advanced altered states of mind. Scientists have shown that both relaxation and meditation enhance the physical and mental health of those who consistently practice these techniques. For example, they help lower blood pressure. See Herbert Benson, MD, The Relaxation Response, Harpertorch 2000.

In order to facilitate entering a state of relaxation or a meditative state, experts recommend concentrating one's mind on a single pattern or on a repetitive process such as breathing, while trying to exclude all other external or internal inputs (noises, thoughts, etc.). Entering meditative states is not easy, especially for beginners. On the other hand, just learning how to relax by regulating one's breath, without even entering the meditative state, is easier, yet it also helps reduce stress and enhance well-being (ibid). It is desirable to be able to relax and meditate in public places and without attracting the attention of other people who might be present. The necessary intense concentration is even more difficult to sustain in such environments (e.g. in the office or in a bus, train, plane).

Several electronic devices, that help facilitate relaxation and meditation are commercially available. These include music players such as Apple Computer's iPod, Sony's Walkman, and many others, which can play special relaxation sounds or repetitive sound patterns. More advanced devices, such as the Proteus™ programmable device sold by 3PoundUniverse.com, provide an acoustical signal for headphones as well as a synchronized color output through special glasses. Furthermore, the Proteus™ system has the capability of linking with Synetic System's ThoughtStream™ skin-resistance-sensing device for biofeedback. A more elegant recent device marketed as the “Stresseraser” by Helicor, Inc. (patents pending) provides visual feedback about the state of relaxation by detecting the pulse rate. The “RESPeRATE” apparatus, marketed by InterCure™, measures the breathing rate and provides feedback geared specifically toward helping reduce blood pressure (See U.S. Pat. Nos. 5,423,328 and 6,090,037).

These devices are conspicuous by their bulk, occupying space on a desk or table, while they provide limited specific feedback about breathing.

Thus there is a need for a discretely portable (e.g. wearable under one's garments) apparatus to help individual users regulate their breathing in order to achieve relaxation or enter meditation. Such apparatus should include adequate means for sensing the breathing function and providing additional feedback about breathing.

### SUMMARY OF THE INVENTION

The foregoing need is met by an illustrative embodiment of the invention (designated in the sequel as the apparatus), which comprises a flat elongated piece of elastically flexible material attached to an upper loop at one of its ends along its length; a lower loop made of the same elastically flexible material as the elongated piece and affixed to its other end, whereby both loops are contained in planes substantially perpendicular to the elongated piece; one or more electromechanical sensors affixed to the lower loop for detecting the breathing of the wearer of the apparatus; a plurality of electrical transducers attached to the elongated piece along its length for providing tactile sensations on the skin; electronic circuitry for powering, signal processing, controlling, sensor-signal detecting, and pulse-generating for energizing the transducers at selected adjustable sequences and rates; and electrical wiring for interconnecting sensors and transducers to the electronics. The apparatus, resembling a harness, is worn on the torso with the upper loop slung around the neck of the user and the lower loop strapped around the waist, thus holding the elongated piece extended from the top of the sternum to the navel and substantially touching the skin of the chest along its length.

In this, as well as in all subsequent illustrative embodiments of the apparatus:

The electronic signal processing is digital and controlled by software or firmware. As an option, the signals between the various components of the electronics could be transmitted and received wirelessly. The electronic circuitry sets the sequential operation of the transducers at the desired breathing rate or allows them to follow the user's breathing as detected by the sensors, at the control of the wearer. During operation of the apparatus the transducers provide tactile or other feedback to the user about his/her breathing rate and depth, thus helping the induction of relaxation.

As an option, the electronic circuitry could drive, for example, acoustical headsets or visual displays with signals emulating those energizing the transducers.

Another illustrative embodiment of the invention comprises, in addition, a second semi-flexible elongated piece of substantially equal shape and dimensions as the first-mentioned elongated piece, such second elongated piece being affixed between the upper loop and the lower loop and positioned opposite the first elongated piece i.e., along the spine; a plurality of transducers attached to the second elongated piece along its length and connected to the electronic pulse generating means; as well as all the additional elements described above at the end of the first illustrative embodiment of the invention as common to all subsequent illustrative embodiments. The purpose of the second elongated loop is to be in substantial contact with the skin along the spine from the nape of the neck to the waist, so that its transducers produce sensations on the skin of the back at the desired or natural rate of exhaling, while the first elongated piece's transducers produce sensations on the skin corresponding to inhaling (or vice versa).

Still another illustrative embodiment of the invention comprises one or more additional loops made of the same elastically flexible material and perpendicularly affixed to the elongated piece between the upper loop and the lower loop. Such additional loops further help secure the flat elongated pieces to the torso and could contain sensors providing additional sensing of the thorax movements during breathing. This embodiment also contains all the additional elements described above at the end of the first illustrative embodiment of the invention as common to all subsequent illustrative embodiments.

A further illustrative embodiment of the invention comprises an elastic garment worn on the torso resembling a blouse or T-shirt; one or more electromechanical sensors embedded in the garment for detecting the breathing thorax and diaphragm movements of the wearer; a plurality of electrical transducers for providing sensations on the skin;

as well as all the additional elements described above at the end of the first illustrative embodiment of the invention and common to all subsequent illustrative embodiments.

### BRIEF DESCRIPTION OF THE DRAWINGS

These and further features and advantages of the present invention will become apparent from the following detailed description taken together with the drawings in which:

FIG. 1 shows a schematic front view of a relaxation inducing apparatus according to the first embodiment of the invention as mounted on a model of a human torso.

FIG. 2 shows a schematic perspective view of the apparatus, without the model of a human torso, and includes elements of further illustrative embodiments.

### DETAILED DESCRIPTION

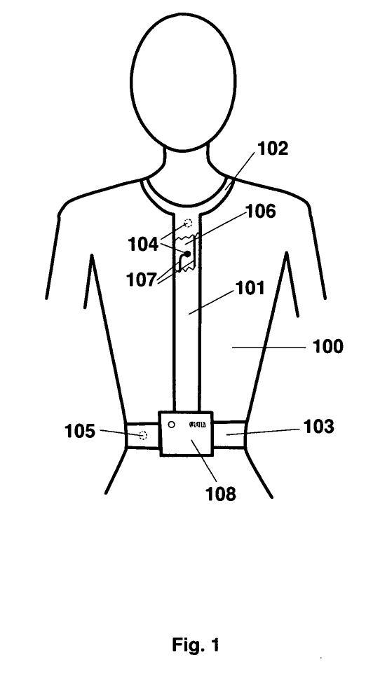

FIG. 1 shows a front view of a first illustrative embodiment of the relaxation inducing apparatus in accordance with the present invention, which apparatus is shown for illustration purposes mounted on the model of a human torso 100.

The apparatus is made of elastically flexible material allowing it to conform tightly to the torso of a user. The apparatus comprises a flat elongated piece 101 terminating at its upper end in an upper loop 102 and at its lower end in a lower loop 103, both loops extending in a direction substantially perpendicular to the elongated piece 101. The upper loop 102 is adapted to be slung around the neck of a user and the lower loop 103 is worn like a belt at the waist.

A number of electronic transducers 104 are attached to or, preferably, embedded within the elongated piece 101 along its length, extending from the top of the sternum to the navel. The transducers 104 are positioned so as to substantially touch the skin under the pressure of the elastically flexible elongated piece 101 and provide short tactile (e.g. vibratory, percussive) or mild electrical discharge sensations on the skin, when operated by electrical pulses.

The belt-like lower loop 103 elastically changes its length following the periodic extension and retraction of the abdomen during breathing. At least one electromechanical sensor 105 attached to or, preferably, embedded into loop 103 produces periodic electrical signals substantially synchronous with and proportional to variations in the lower loop's length. The amplitude of these periodic electrical signals corresponds to the depth of breathing while the period of these signals reveals the rate of the wearer's diaphragmatic breathing. The electromechanical sensors can be for example of strain gage, piezo-resistive, capacitive, or inductive type. A section 106 of the elongated piece 101 is shown cut open so as to reveal one of the transducers 104 as well as sections of electrical wiring 107 interconnecting the transducers to the electronics.

The electronic circuitry for operating the apparatus may be enclosed in a case 108 attached to the lower loop as shown in FIG. 1 or, preferably, may be embedded within the lower loop 103. The electronic circuitry comprises a power source consisting either of standard or rechargeable batteries, sensor-signal detecting circuitry, pulse generating circuitry for energizing the transducers 104 at selected adjustable sequences and rates, digital signal processing means, and a control interface. Alternately, the control interface could be physically separate from the lower belt 103, such as for example being enclosed in a small separate case, which fits in the palm of the hand of the user and communicates wirelessly with the rest of the electronic circuitry by such well-known means as the Bluetooth standard.

During operation of the apparatus, the electronic circuitry provides the pulses necessary for operating the transducers 104 in upward and downward sequences at a rate set to the actual or to the desired rate of breathing. For example, the downward sequential operation of the transducers 104 would provide an enhanced sense of the movement of air into the lungs (i.e. inhalation) and the upward sequential operation of the transducers 104 would emulate the flow of air out of the lungs (i.e. exhalation). Alternately, a user may select opposite directional sequences to correspond to the inhalation and the exhalation, respectively. Furthermore, the breathing depth can be indicated by the number of transducers that are activated and/or by the intensity of the tactile sensation. Induction of relaxation is helped by setting the sequencing rhythm of the apparatus to the desired rate, which is usually slower than the natural breathing rhythm, as is required by deep breathing for example. Based on the tactile feedback of the transducers, the users are thus helped to adjust their breathing accordingly.

Additional electronic means could be provided for generating output signals emulating the signals operating the transducers 104 for optional external devices. One such optional external device includes an acoustical headset coupled to the electronic circuitry that operates the apparatus either via a wired connection or a wireless connection, e.g. via a Bluetooth standard wireless link. The acoustical signal could be a series of pleasant musical tones moving along a musical scale downwards (in pitch) during inhaling and upwards during exhaling (or vice versa), such tones being coincident in time with the sequential pulses activating the transducers 104. Wearing the headset has the additional advantage of reducing the perception of outside noise, especially if the headset contains acoustic noise canceling circuitry. Another optional external device is a visual display on the Bluetooth-operated separate hand-held control interface mentioned above. Such a display could indicate the breathing rate and depth numerically or graphically, as well as settings and other data related to the operation of the relaxation inducing apparatus.

The electronic circuitry can be implemented by means that are well known to those skilled in the art, and that are commercially available, such as Application Specific Integrated Circuits (ASICs) under the control of a programmable, general-purpose microprocessor. See for example Martin Hartley Jones, “A Practical Introduction to Electronic Circuits,” Cambridge University Press 1995.

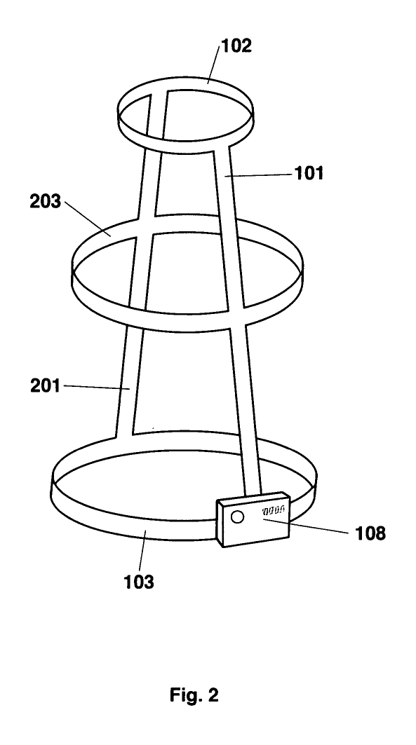

FIG. 2 shows a perspective view of another illustrative embodiment of the invention, which is also to be worn on the torso of a user (not shown in FIG. 2). This embodiment derives from and augments the one shown in FIG. 1. It comprises an additional flat elongated piece 201 of the same material and of substantially equal shape and dimensions as those of the first elongated piece 101. The additional elongated piece 201 is affixed between the upper loop 102 and the lower loop 103 and as shown positioned opposite the first elongated piece 101. The additional elongated piece 201 also contains a plurality of transducers (not shown in FIG. 2) substantially identical and substantially identically arranged as transducers 104 of the first elongated piece 101. When the apparatus is worn on the torso of a user, this additional elongated piece 201 fits along the spine on the back of the body staying in substantial contact with the skin. Its transducers produce tactile sensations on the skin from the nape of the neck to the back of the waste corresponding to exhaling, while the first elongated piece's transducers 104 produce corresponding sensations on the skin of the chest representing inhaling (or vice versa). Other time-sequential arrangements can also be programmed. The rest of the apparatus and its functions, including all electronics, are identical to the first embodiment described above.

Yet another illustrative embodiment of the invention, also deriving from and augmenting the one depicted in FIG. 1, comprises one or more additional loops affixed substantially perpendicularly to the elongated pieces 101 and 201 between the upper loop 102 and the lower loop 103. One such additional loop is depicted in FIG. 2 as element 203. The additional loops can further help secure the flat elongated piece(s) 201 and/or 101 to the torso and can also provide additional sensors of the thorax movements during breathing, if so desired.

Still another illustrative implementation of the invention comprises all elements shown in FIGS. 1 and 2 on the same harness.

In accordance with a further illustrative embodiment of the invention, the elongated piece(s) 101, 201 and the perpendicular loop(s) 102, 103, 203 of the previous implementations are replaced by an upper—body garment—akin to a blouse or T-shirt-worn on the torso. The garment is made of fabric material including elastic fibers for tightly fitting to the skin of the user while following the thoracic and diaphragmatic breathing movements. A garment fabric made of 80% nylon and 20% Lycra™ Spandex satisfies these elasticity requirements, while also allowing breathing of the skin. All sensors and transducers are positioned on or in the garment and arranged as already described in the previous illustrative implementations. The rest of the electronics could also be embedded into the garment. The rest of the apparatus and its functions, including all electronics, are identical to those of the first embodiment described above.

Methods and techniques for embedding electronic circuitry in garments are described in Lucy E. Dunne, Susan P. Ashdown, and Barry Smyth, “Expanding Garment Functionality through Embedded Electronic Technology,” Journal of Textile and Apparel Technology and Management, Volume 4. Issue 3, Spring 2005. This publication also includes an extensive list of relevant references.

It is to be understood that the above-described illustrative embodiments have been presented merely to illustrate the pertinent inventive concepts of the present invention. Numerous other modifications may be devised by those skilled in the art, without departing from the spirit, principles, teachings, and scope of the invention.

What is claimed is:

1- A relaxation inducing apparatus comprising:
a flat elongated piece made of elastically flexible material having two opposite ends along its length;
a plurality of electrically operated transducers attached to said elongated piece along its length for producing signals detectable by the human senses;
a first loop affixed to the upper end of said flat elongated piece and extending in a direction substantially perpendicular to said elongated piece;
a second loop made of elastically flexible material affixed to the lower end of said flat elongated piece and extending in a direction substantially perpendicular to said elongated piece;
at least one electromechanical sensor attached to said second loop for producing electrical signals essentially proportional to variations in the length of said second loop; and
electronic circuitry for processing said electrical signals produced by said electromechanical sensor and for operating said transducers at selected adjustable sequences and rates.

2- An apparatus according to claim 1 further comprising means coupled to the electronic circuitry for generating output information signals representative of the operation of the relaxation inducing apparatus.

3- An apparatus according to claim 1 wherein:
said plurality of electrically operated transducers are embedded in said flat elongated piece; and
said sensor is embedded in said second loop.

4- An apparatus according to claim 1 further comprising:
an additional elongated piece made of elastically flexible material and of substantially equal shape and dimensions as said flat elongated piece, wherein said additional elongated piece is affixed between said first loop and said second loop and positioned opposite said flat elongated piece; and
a second plurality of electrically operated transducers attached to said additional elongated piece, substantially identical and substantially identically arranged as said transducers of said flat elongated piece.

5- An apparatus according to claim 4 wherein:
said plurality of electrically operated transducers are embedded in said flat elongated piece;
said second plurality of electrically operated transducers are embedded in said additional elongated piece; and
said sensor is embedded in said second loop.

6- An apparatus according to claim 1 further comprising:
At least one additional loop made of elastically flexible material and affixed to said elongated piece between said first loop and said second loop and extending in a direction substantially perpendicular to said flat elongated piece; and
at least one additional electromechanical sensor attached to said additional loop for producing electrical signals essentially proportional to variations in the length of said additional loop.

7- An apparatus according to claim 6 wherein:
said plurality of electrically operated transducers are embedded in said flat elongated piece;
said electromechanical sensor is embedded in said second loop; and said additional electromechanical sensor is embedded in said additional loop.

8- An apparatus according to claim 1 further comprising:
an additional elongated piece made of elastically flexible material and of substantially equal shape and dimensions as said flat elongated piece, wherein said additional elongated piece is affixed between said first loop and said second loop and positioned opposite said flat elongated piece;
a second plurality of electrically operated transducers attached to said additional elongated piece, substantially identical and substantially identically arranged as said transducers of said flat elongated piece;
at least one additional loop made of elastically flexible material and affixed to said elongated piece between said first loop and said second loop and extending in a direction substantially perpendicular to said flat elongated piece; and
at least one additional electromechanical sensor attached to said additional loop for producing electrical signals essentially proportional to variations in the length of said additional loop.

9- An apparatus according to claim 7 wherein:
said pluralities of transducers are embedded in their respective elongated pieces; and
said sensors are embedded in their respective loops.

10- A relaxation inducing apparatus wearable on the torso and comprising:
A tightly-fitting upper-body garment made of elastically flexible fabric;
a plurality of electrically operated transducers attached to or embedded in said garment in a vertical direction from the sternum to the navel in front of said garment and from the nape of the neck to the waist in the back of said garment for producing tactile sensations on the skin;
one or more electromechanical sensors attached to or embedded in said garment for producing electrical signals substantially proportional to the thoracic and diaphragmatic breathing movements; and
eletronic circuitry for processing said electrical signals produced by said sensors and for operating said transducers at selected adjustable sequences and rates.

11- An apparatus according to claim 10 further comprising means coupled to the eletronic circuitry for generating output information signals representative of the operation of the relaxation inducing apparatus.
